(19) United States
(12) Patent Application Publication
(10) Pub. No.: US 2005/0102519 A1
(43) Pub. Date: May 12, 2005

(54) Method for authentication of a user for a service offered via a communication system

(75) Inventor: Hans-Jochen Morper, Erdweg (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/947,608

(22) Filed: Sep. 23, 2004

(30) Foreign Application Priority Data
Sep. 24, 2003 (EP) 03021582.6

(51) Int. Cl. H04L 9/00; H04K 1/00

(52) U.S. Cl. 713/170

(57) ABSTRACT

A method for the authentication of a user for use of a service offered via a first communication system, with the user being authenticable by an authentication unit that can be unambiguously assigned to the user, and enables authentication of the user in a second communication system. Information on the authentication unit being available in a service device, with the second communication system communicating the data enabling authentication of the user. The service device transmits data to the authentication unit, enabling authentication of the user, whereby a response, specific to an authentication unit occurs. A check for correctness of the response specific to the authentication unit taking place in the first communication system or in the second communication system occurs, and communication corresponding to the service taking place between the user station and the first communication system occurs, depending on the result of the check.

This application claims the benefit of priority to European Application No. EP 03021582.6, filed on Sep. 24, 2003, the contents of which are hereby incorporated by reference.

### TECHNICAL FIELD OF THE INVENTION

The invention relates to a method for authentication of a user for use of a service offered by a communication system. The invention also relates to a service device in a communication system and a computer program product that is suitable for a service device.

### BACKGROUND OF THE INVENTION

For communication or for transfer of data, a number of diverse communication systems are known. E.g. mobile radio communication systems exist, for example according to the GSM (Global System for Mobile Telecommunications) standard or the UMTS (Universal Mobile Telecommunications System) standard, whereby mobile stations are authenticated and authorized when checking in to the relevant network. The advantage of systems of this kind is that the authentication means that charging of loaded services is also possible. Furthermore, this normally enables cellular networks to have a higher mobility because the user can move from network cell to network cell with his mobile station. A disadvantage of this kind of cellular mobile radio communication system is that the administration costs are very high. Furthermore, these systems make only relatively low data throughputs available to the radio interfaces to the user mobile station.

In mobile radio communication systems information (for example voice, picture information, video information, short messages (SMS, Short Message Service) or other data) is transmitted between the transmitting and receiving station via a radio interface with the aid of electromagnetic waves. The electromagnetic waves in this case are radiated with carrier frequencies that lie within the frequency band provided for the particular system. A cellular mobile radio communication system in this case includes user stations, e.g. mobile stations and base stations, e.g. node B's, devices for radio access control and for controlling the base stations, as well as further devices at the network end.

Further networks exist, that are configured as local networks (LAN, Local Area Network) or local radio networks (WLAN, Wireless Local Area Network). Networks of this kind offer an access that is technically very easy to administer for subscriber devices. A further advantage is the substantially higher data throughput on the interfaces to the user station compared with mobile radio networks. A disadvantage of such local networks is, however, the absence of an authentication facility within the network and thus also the absence of a charging facility.

A further example of a communication system is the Internet. Subscribers often use a PC for their Internet access, increasingly also portable devices such as Notebooks or PDAs (Person Digital Assistant). If a user intends to use a charged service offered through the Internet, if goods are sold through the Internet, or if confidential information is transmitted, the service provider will normally perform an authentication and ensure authorization of the user. With regard to the user subscribed for the particular service, this can normally take the form of a usual, unsafe method, such as the user name in conjunction with a password. For ad hoc access, an authentication by means of a credit card number is usually used, but this is often rejected by the user, so that a particular service is then not used.

### SUMMARY OF THE INVENTION

The invention provides a secure method for authentication of a user for use of a service offered via a communication system, as well as a device in the communication system for performing the method and a computer program product for supporting the performance of the method.

In one embodiment of the invention, there is a method for authentication of a user for use of a service offered via a first communication system, the user communicates with the first communication system by means of a user station. The user can be authenticated by an authentication unit, that can be unambiguously assigned to the user and enables the user to be authenticated, in a second communication system. Information on the authentication unit is available in a service device of the first communication system. When requested by the data device regarding information on the authentication unit, the second communication system transmits the data enabling the authentication of the user to the service device. The service unit sends at least a part of the data enabling the authentication of the user to the authentication unit. At the user end, a response specific to the authentication unit is received by the receiver of the data enabling the authentication of the user and is passed to the first communication system. In the first communication system, or in the second communication system, the authentication-unit-specific response is checked for correctness. Depending on the result of the check, communication corresponding to the service takes place between the station at the user end and first communication system.

In on aspect of the invention, communication by the user station with the first communication system, through which the service under consideration is offered, can also take place via one or more different communication systems. For example, the user station can, by means of a WLAN or a WMAN (Wireless Metropolitan Area Network), use services that are offered via the Internet.

In another embodiment of the invention, the first communication system through which the service is offered can be a mobile radio communication system. In a case where the second communication system within which the user can be authenticated by the authentication unit is also a mobile communication system, this can differ from it particularly with regard to the RAT (Radio Access Technology) or the operator. It is also possible to use the same radio access technology for the first and second communication systems. Regardless of the actual design of both communication systems, the user cannot be authenticated within the first communication system by the same authentication unit as within the second communication system.

In still another embodiment of the invention, the first communication system and the second communication system are separate from each other with regard to authentication, i.e. they have no common devices that are used for authentication. It is therefore, in particular, impossible for the first communication system to access devices and memories, such as the HLR (Home Location Register) of the second communication system. However, in the event of roaming between two mobile communication systems, both systems access the same HLR, that in this regard is common to both systems. It is also possible for the first communication system and the second communication system to be completely separate from each other, i.e. although they may have a suitable interconnection they have no common devices.

The authentication unit enabling authentication of the user and unambiguously assigned to the user can, for example, be a hardware unit, e.g. a SIM card (Subscriber Identity Module), a USIM card (USIM: UMTS SIM) or a SMART card. It is also possible for the authentication unit to be a software unit. The authentication unit is thus characterized in that it can be unambiguously assigned to the user and has a mechanism for authentication of the user. A SIM card is, for example, clearly characterized by the IMSI (International Mobile Subscriber Identity). If a user has only one SIM card and if only one telephone number is assigned to him, the SIM card can also be unambiguously identified by means of the MSISDN (Mobile Station ISDN Number).

In another embodiment of the invention, the service that is offered via the first communication system, i.e. in the context of which a communication takes place between a user using the service and the first communication system, can, for example consist of differently configured applications. The service can be offered by the operator of the first communication system or by third parties. The service device used as part of the authentication can as a rule be a device of the provider of the service. It is a part of the first communication system to the extent that it is connected to it and can communicate through it to other devices and user stations.

Information on the authentication unit is available in the service device of the first communication system. This availability can also be realized by a permanent or temporary storage of information in the service device. The information can thus be available in that it is requested by the user or downloaded from a different device of the first communication system. It can also be available only temporarily in the service device.

After the user has been successfully authenticated, he is admitted to the relevant system, i.e. communication corresponding to the service can take place between the user station and the first communication system through with the service is offered.

In still another embodiment of the invention, the authentication unit is connected to a communication terminal. This communication terminal is connected to the user station via an interface, that can be realized by radio or connected by a line. The connection of a hardware authentication unit with the communication terminal can, for example, be achieved by plugging the hardware authentication unit into the communication terminal, or also through a radio interface. A connection between the hardware authentication unit and the communication terminal that is unremovable by the user is also possible. The connection of a software authentication unit with a communication terminal can, for example, be achieved by storing a program on the communication terminal or by connecting the communication terminal to a suitable storage medium for the program.

It is advantageous if the type of data enabling authentication of the user corresponds to the type of data used to authenticate the user in the second communication system. This means that a data record transmitted from the second communication system to the first communication system for authentication of the user is configured in such a way that it can be used in the second communication system to authenticate the user. In particular, it is, for at least part of the data enabling authentication of the user, data that can be verified exclusively by the authentication unit of the user by the response specific to the authentication unit.

In yet another embodiment of the invention, the information on the authentication unit is a telephone number of the second communication system assigned to the authentication unit.

Advantageously, the service unit sends a message to the user station requesting the information, before the information on the authentication unit is available in the service unit of the first communication system. The user station then responds to this message by transmitting the requested information.

The service device in accordance with the invention, in a first communication system, has a device for transmitting a message to a user station of a subscriber to request information on an authentication unit, that can be unambiguously assigned to the user and enables authentication of the user. Furthermore, the service unit has a device for receiving information on the authentication unit from the user station, and a device for sending a message to a second communication system, in which the authentication unit can be used for authentication, to request data enabling the authentication of the user, with reference to the information on the authentication unit. Further components of the service device are a device for receiving from the second communication system the data enabling authentication of the user, a device for sending a message with at least one part of the data enabling authentication of the user to the user station, a device for receiving a response, specific to an authentication unit, to the data received by the user station enabling the authentication of the user, from the user station, and finally a device for admitting the user station, depending the result of a check for correctness of the response, to a service offered through the first communication system.

Advantageously, the service unit also has a device for checking the correctness of the response specific to the authentication unit. Finally, the service unit can have a device for storing at least part of the data enabling the authentication of the user.

The service device in accordance with the invention is particularly suitable for performing the method in accordance with the invention. For this purpose, it can have further suitable devices.

In another embodiment of the invention, a computer program product for a first communication system performs the following:
a) Creation of a message to a user station of a user to request information regarding an authentication unit that can be unambiguously assigned to the user and enables authentication of the user.
b) Processing information on the authentication unit received from the user station.
c) Creating a message to a second communication system in which the authentication unit can be used for authentication, for requesting data enabling authentication of the user with reference to the information on the authentication unit.
d) Processing data enabling authentication of the user, received from the second communication system.
e) Creating a message to the user station, with at least part of the data enabling the authentication of the user.
f) Processing a response received from the user station, specific to the authentication unit, to the data received by the user station enabling the authentication of the user.
g) Allowing the user station access to a service offered through the first communication system, depending on the result of a check for correctness of the response.

In still another embodiment of the invention, checking the correctness of the response can be provided.

It is possible in each case that the portion of program that serve to create messages can also control the transmission of the created messages. Furthermore, it is possible in each case that the portion of the program used for processing the received messages can control the reception of these messages.

The program described can be stored in the service device in accordance with the invention and can run there. Furthermore, it is possible that individual, or all, parts of the computer program product can be loaded from the service device in accordance with the invention from one or more servers, and then run on the service device. To support the method in accordance with the invention, the computer program product in accordance with the invention is not limited to these limitations.

### BRIEF DESCRIPTION OF THE DRAWINGS

The invention is described in more detail below with reference to exemplary embodiments illustrated in the drawings, in which:

FIG. 1 shows the Internet and a mobile radio communication system.

FIG. 2 shows a flow diagram of the method in accordance with the invention.

FIG. 3 shows a service device in accordance with the invention for a communication system.

### DETAILED DESCRIPTION OF THE INVENTION

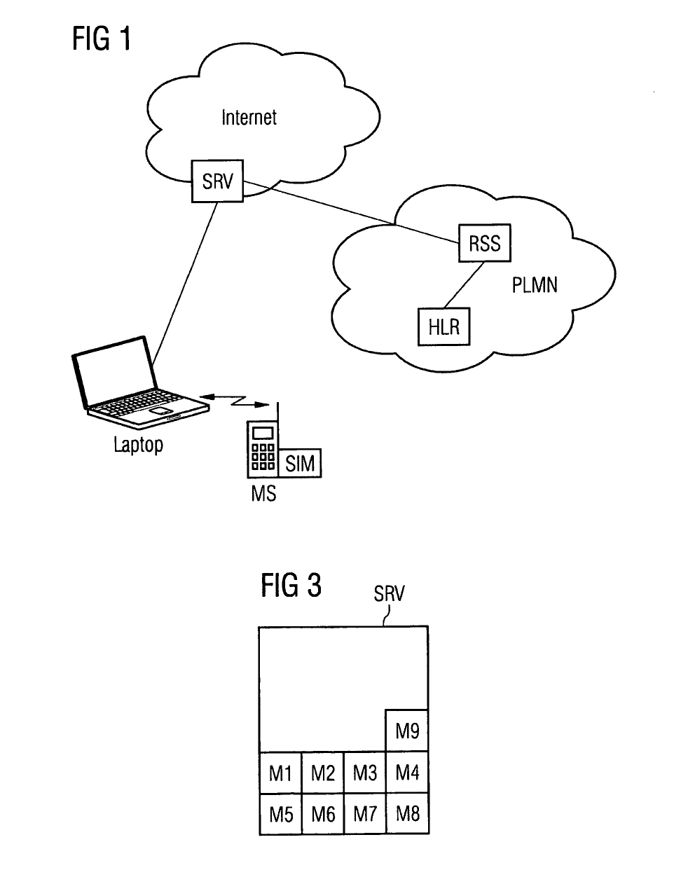

FIG. 1 shows as an example of a communication system the Internet INTERNET, to which a user has access by means of a computer LAPTOP. This access can, for example, by achieved by means of a LAN, WLAN, GPRS (General Packet Radio Service) or modem dialing. The user uses a browser for this purpose, that is able to establish an http (Hypertext Transfer Protocol) connection or a secure http-s connection to a server SRV of a service provider, who provides a service via the Internet INTERNET.

If the user intends to use a charged service of the service provider, such as a stock exchange service, or wishes to purchase goods on the Internet as part of a suitable service, an authentication of the user before or during the course of the use of the service is necessary. This authentication serves mainly to safeguard the service provider or seller with regard to payment.

In the example in FIG. 1 it is assumed that the user has a mobile telephone MS with him, that is fitted with a SIM card SIM. The SIM card SIM that, for example, contains the IMSI and the MSISDN, enables the authentication of the user in the mobile radio telecommunication system PLMN. This mobile radio communication system PLMN can, for example, be designed according to the GSM or UMTS standard, can include an AAA (Authentication, Authorization and Accounting) server RSS for providing services for authentication of users, for checking access authorization or authorizing these users for certain services and/or resources, as well as for logging the activities of these users. Furthermore, the device HLR (Home Location Register), that has a database in which the permanent data of the user of the mobile radio communication system PLMN is administered, is present in the mobile radio communication system PLMN. The AAA server RSS is designed in such a way that it can request data, that enables authentication of the user, from the device HLR and forward same.

Whereas the SIM card can be used in the mobile radio communication system PLMN for authentication, a direct authentication of the user within the Internet INTERNET is not possible.

The mobile telephone MS has a suitable interface for communication with the computer LAPTOP of the user. This communication can be wireless, e.g. via infrared or Bluetooth or via cable, such as serial or by USB (Universal Serial Bus). A direct connection of the mobile telephone MS via a card reader to the computer LAPTOP is also possible.

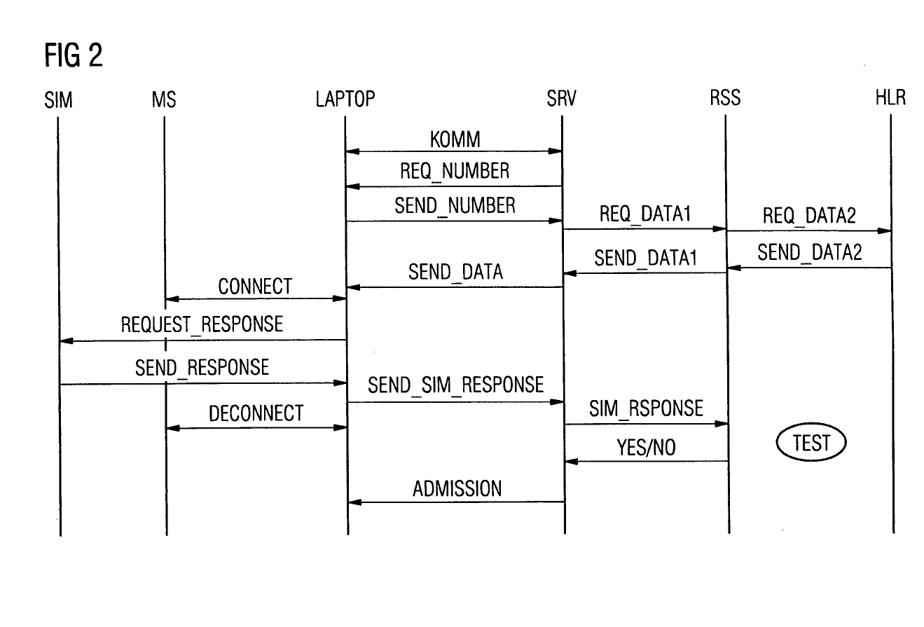

A flow diagram of the method in accordance with the invention is shown in FIG. 2, with communication taking place between the SIM card SIM, the mobile telephone MS, the computer LAPTOP, the Internet server SRV, the AAA server RSS and the device HLR. Because of a suitable interaction between the mobile radio communication system or its operator, the service provider, or service provider of an Internet service, and the user, or his computer and his mobile telephone for a user, the invention enables the Internet service to be used safely and reliably or enables the service provider to offer the service in a correspondingly secure and reliable manner.

At the start of the flow diagram in FIG. 2, a communication takes place between the computer LAPTOP of the user and the Internet. As part of this communication, a connection KOMM is established between the computer LAPTOP and the server SRV of the service provider of a service requested by the user. The communication between the computer LAPTOP and the server SRV usually takes place by means of several devices forwarding the particular messages. By means of a message REQ_NUMBER, the user is requested by the server SRV to enter his access data. This can, for example, takes place by means of a request for the mobile telephone number on a portal end of the Internet. By means of the message SEND_NUMBER, the mobile telephone number that the user has typed into the computer LAPTOP is sent from the computer LAPTOP to the server SRV.

The mobile telephone number of the user, that can be used to identify the SIM card SIM is, for example, transmitted via a Radius/Diameter (Radius: Remote Authentication Dial In User Service) connection from the server SRV to the AAA server RSS of the mobile radio communication system. By using the message REQ_DATA1, a request for data that enables authentication of the user is made. The AAA server RSS then sends a corresponding request for authentication data to the device HLR by means of the message REQ_DATA2, e.g. via CCS7/MAP (CCS7: Common Channel Signaling No. 7, MAP: Mobile Application Protocol).

The authentication of a user by means of his SIM card takes place in mobile radio communication systems, normally by using number triplets. A triplet consists in this case of a random number, a response to the random number and a key. The key is used to encrypt the subsequent data transmission after successful authentication. The random number and the key are sent to a SIM card as part of the authentication, whereupon the SIM card decides a response to the random number. The card-specific parameters used by various SIM cards for calculating the response differ from each other, so that the calculated response is specific to the SIM card. The card-specific parameters used for the calculation are also stored in the mobile radio communication system, usually in the device HLR. Verification of the response as a part of the number triplet can thus take place only by the correct, and thus authenticatable, SIM card.

A number triplet normally used within the mobile radio communication system PLMN for authentication is sent by means of the message SEND_DATA2 to the AAA server RSS, that forwards the information enabling the authentication to the server SRV of the service provider by means of the message SEND_DATA1.

The server SRV sends the random number and the key to the computer LAPTOP by using the message SEND_DATA. It is also possible to send a random number without the key by means of the SEND_DATA message. After the establishment CONNECT of a connection between the computer LAPTOP and the mobile telephone MS, that was activated on the basis of the reception of the random number in the computer LAPTOP, the random number is sent from the computer LAPTOP to the SIM card SIM by using the message REQUEST_RESPONSE, with the request to determine the corresponding response. After determining the response, i.e. the SIM-card-specific response to the random number, the SIM card sends the determined response via the mobile telephone MS to the computer LAPTOP with the message SEND_RESPONSE. Then, the disconnection DECONNECT of the connection between the computer LAPTOP and the mobile telephone MS takes place. Communication between the computer LAPTOP and the mobile telephone MS of the user in this case takes place without intermediate switching of the actions of the user being necessary.

The response determined by the SIM card SIM is transmitted from the computer LAPTOP to the server SRV with the message SEND_SIM_RESPONSE. This then passes on the response to the AAA server RSS with the message SIM_RESPONSE. The message SIM_RESPONSE corresponds to an explicit or implicit request to check the response for correctness. In the mobile radio communication system, a check TEST for correctness of the response then takes place. In the case where the mobile radio communication system carries out the check TEST, it is sufficient instead of sending the complete number triplet to send the random number, or the random number and the key, from the mobile radio communication system to the server SRV of the service provider with the message SEND_DATA1.

If it is found within the mobile radio communication system that the response agrees with the answer of the number triplet, successful authentication is confirmed with the message YES/NO. In the case where no agreement is found, the failed authentication is signaled by means of the message YES/NO. It is thus made known to the server SRV by means of the message YES/NO whether or not the user has permission to access the service or not.

As an alternative, the server SRV can also carry out a check for agreement between the response determined by the SIM card SIM and the response sent previously from the device HLR with the message SEND_DATA1 as part of the number triplet.

If the response determined by the SIM card SIM is correct, the user is approved for admittance to the desired service, or the service is made available, which is then communicated by a message ADMISSION from the server SRV to the computer LAPTOP. In the following, the data transmission between the server SRV and the computer LAPTOP then takes place in accordance with the requested service, such as the transmission of share prices as part of a stock exchange service. If a discrepancy between both values for the response is detected, then the user is rejected for the particular service (not shown in FIG. 2).

It is advantageous, for example as part of a subscription service, if the user leaves his mobile telephone number with the service provider during the subscription. In this case, it is then not necessary for the server of the service provider to ask for the mobile telephone number before each use of the service and the user does not have to type his mobile telephone number into the computer. Rather, the service provider can establish the link to the particular mobile telephone number on the basis of the identification information of the user. Otherwise, the procedure can be carried out as described above. Action by the user is not necessary in this case, but instead the authentication takes place out of sight of the user, completely in the background, so that he receives a seamless service.

Furthermore, it is not necessary for the SIM card to be part of a mobile telephone. Instead the method in accordance with the invention can also be used directly through SIM cards plugged into a Notebook, e.g. by means of a SmartCard or USB dongle. However, it is very often appropriate for administrative or networked topology reasons to use one single SIM card per user. The result of this is that a data record for each SIM card is held in the HLR, which means that fixed costs per SIM card result. Furthermore, customers who have several SIM cards would not usually want a bill for each SIM card, but instead a common bill for their SIM cards, so that the bills would have to be revised by the operator before submission to the customer.

With the method in accordance with the invention, almost all mobile radio users worldwide could be authenticated for services of communication systems, because there are roaming agreements between almost all mobile radio communication systems worldwide. To do this, the mobile radio communication system contacted by the server accesses a suitable user database of a different mobile radio communication system with which there is a roaming agreement.

An advantage for the user is that with the method described he does not have to note any information such as a password for a service. For providers of services on the other hand it is advantageous that because of the simple and secure authentication method, particularly without using credit card numbers, an increasing number of users can be expected for the particular services.

With the method in accordance with the invention for authentication of a user for a service that is offered via a communication system there is generally no need for authentication of the user for a connection or communication with the communication system. Instead, the user can communicate directly with the communication system or be authenticated within the communication system before the method in accordance with the invention for authentication of the user for the service is performed. The authentication as part of the invention takes place exclusively with reference to a service requested by the user, which is why the steps of the method in the network are performed by a server of the particular service provider.

FIG. 3 shows such a server SRV in accordance with the invention. This has means M1 for sending a request to a user station for transmission of information on a SIM card. This request can take place once, e.g. for the subscription of the user, or also each time the service is used. Furthermore, the server SRV has means M2 for receiving the requested information, e.g. in the form of the mobile telephone number of the SIM card, and means M3 for sending a request to a mobile radio communication system to request authentication data with reference to information on the SIM card. Means M4 serves for receiving the requested data enabling authentication of the user, means M5 is used for sending at least part of the authentication data to the user station, means M6 is used for receiving the response determined by the SIM card, and means M7 for allowing access by the user station to the particular service depending on the check of the response for correctness. The check in this case can take place either in the server SRV using means M8 or also in the mobile radio communication system. Access by the user to the service requested by him can be provided either explicitly by a positive access confirmation or implicitly by communicating information that is part of the service. Furthermore, the server SRV in accordance with the invention can have means M9 for storing data that enables authentication of the user. This storage can be either permanent or temporary.

Whereas the server SRV in FIGS. 1 and 3 is shown as a device forming part of the structure, the server in accordance with the invention can also be realized by several structurally separate devices connected to each other by suitable interfaces.

1. A method for authentication of a user for use of a service offered via a first communication system, comprising:
communicating via a user station with the first communication system after authentication of the user for communication with the first communication system;
authenticating the user by an authentication unit, that is configured to be unambiguously assigned to the user and enables the user to be authenticated, in a second communication system;
providing information on the authentication unit in a service device of the first communication system;
transmitting, via the second communication system, the data, enabling the authentication of the user, to the service device on a request of the service unit with reference to the information on the authentication unit;
sending, via the service unit, at least a part of the data enabling the authentication of the user to the authentication unit;
determining, at the user end, a response specific to the authentication unit to the received data that enables authentication of the user and being passed to the first communication system; and
checking) for correctness of the response specific to the authentication unit in the first communication system or in the second communication system, wherein
a communication corresponding to the service takes place between the user station and first communication system, depending on the result of the check.

2. The method in accordance with claim 1, wherein the authentication unit is connected to a communication terminal that is connected to the user station via an interface.

3. The method in accordance with claim 1, wherein the type of data enabling authentication of the user corresponds to the type of data used to authenticate the user in the second communication system.

4. The method in accordance with claim 1, wherein the information on the authentication unit is a telephone number of the second communication system allocated to the authentication unit.

5. The method in accordance with claim 1, wherein before the availability of the information on the authentication unit in the service device of the first communication system, the service device sends a message to the user station to request the information.

6. A service device in a first communication system for authentication of a user to use a service offered via the first communication system, comprising:
a sending device for sending a message to a user station of the user, that was previously authenticated for communication with the first communication system, to request information on an authentication unit, that is configured to be unambiguously assigned to the user, enabling authentication of the user;
a receiving device for receiving information on the authentication unit from the user station;
a second sending device for sending a message to a second communication system in which the authentication unit is configured to be used for authentication, for requesting data enabling authentication of the user with reference to the information on the authentication unit;
a second receiving device for receiving the data enabling authentication of the user, from the second communication system;
a third sending device for sending a message with at least part of the data enabling the authentication of the user, to the user station;
a third receiving device for receiving a response, specific to an authentication unit, to the data, received by the user station, enabling the authentication of the user, from the user station; and
an access device for allowing access of the user station to the service offered via the first communication system depending on the result of a check for correctness of the response.

7. The service device in a first communication system according to claim 6, further comprising a checking device for checking the correctness of the response specific to the authentication unit.

8. The Service device in a first communication system according to claim 6, further comprising a storing device for storing at least part of the data enabling authentication of the user.

9. A computer program product for a first communication system for authentication of a user for use of a service offered via the first communication system, the computer program product performing the following:
creating a message to a user station of the user, that was previously authenticated for communication with the first communication system, to request information on an authentication unit, that is configured to be unambiguously assigned to the user, enabling authentication of the user,
processing information on the authentication unit received from the user station;
creating a message to a second communication system in which the authentication unit can be used for authentication, for requesting data enabling authentication of the user with reference to the information on the authentication unit;
processing data enabling authentication of the user, received from the second communication system;
creating a message to the user station, with at least part of the data enabling the authentication of the user;
processing a response received from the user station, specific to the authentication unit, to the data received by the user station enabling the authentication of the user; and
allowing the user station access to a service offered through the first communication system, depending on the result of a check for correctness of the response.

10. The computer program product in accordance with claim 9, further comprising checking the correctness of the response.
